(19) United States
(12) Patent Application Publication
(10) Pub. No.: US 2026/0148732 A1
(43) Pub. Date: May 28, 2026

(54) Audio and Language Translation Between Computing Devices

(71) Applicant: eBay Inc., San Jose, CA (US)

(72) Inventor: Yash Ashok Agarwal, San Jose, CA (US)

(73) Assignee: eBay Inc., San Jose, CA (US)

(21) Appl. No.: 18/957,975

(22) Filed: Nov. 25, 2024

(51) Int. Cl. G10L 13/033; G06F 40/40; G10L 15/26

(52) U.S. Cl. CPC G10L 13/033; G06F 40/40; G10L 15/26

(57) ABSTRACT

A computer-implemented method and system provides audio and language translation between a speaker at a first computing device and a listener at a second computing device. The first computing device inputs speech in the speaker’s language pre-defined as corresponding to the speaker, translates the speech from the speaker’s language into audio data in the listener’s language predefined as corresponding to the listener. The first computing device superimposes the speaker’s pronunciation as modeled by a speaker pronunciation model onto the audio data in the listener’s language so that the pronounced audio data in the listener’s language will sound as if it is spoken by the speaker. The speaker pronunciation model is trained on the speaker’s voice speaking the speaker’s language and remains stored at the first computing device. The pronounced audio data is streamed to the second computing device while the speaker at the first computing device is speaking.

### BACKGROUND

Meeting clients often lack robust real-time language translation features, making communication challenging when participants speak different languages. This language barrier can lead to misunderstandings, reduced collaboration, and the exclusion of non-native speakers from fully participating in discussions. Additionally, even with built-in captioning or translation tools, the accuracy and speed of these features may not be sufficient to maintain the flow of conversation, further hindering effective communication.

### SUMMARY

Use of online meeting clients continues to increase along with global outsourcing, exacerbating a problem that participants with different native languages feel a disconnected experience. In one or more implementations, in a video or audio meeting, a participant speaks in their native language such as a non-English language, and another meeting participant hears the speech in their native such as English but it sounds like it was pronounced by the speaker with the speaker’s unique vocal character.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 illustrates portions of audio and language translation between computing devices.

FIG. 3 illustrates portions of audio and language translation between computing devices.

FIG. 4 illustrates portions of audio and language translation between computing devices.

FIG. 5 illustrates another example of audio and language translation between computing devices.

FIG. 6 illustrates another example of audio and language translation between computing devices.

FIG. 7 illustrates another example of audio and language translation between computing devices.

FIG. 8 illustrates another example of audio and language translation between computing devices.

FIG. 9 illustrates portions of a computing device arranged for audio and language translation between computing devices.

FIG. 10 illustrates a procedure in an example implementation of audio and language translation between computing devices.

FIG. 11 illustrates an example of a system that includes an example computing device that is representative of one or more computing systems and/or devices that may implement the various techniques described herein.

### DETAILED DESCRIPTION

### Overview

The need for meeting participants who have different native languages to translate to a same language such as English raises a barrier to effective communication among meeting participants. Various conventional techniques attempt to provide translation of a source language into a target language, with varying degrees of success. As an example of translating audio of a source language into audio in a target language, conventional approaches for real-time call translation involve performing translation of the audio of a source user into audio in a target language and translation of the audio of the target user back to audio in the source language during the call. For instance, some such conventional techniques utilize a translation engine that accepts speech using a speech recognition unit, performs Speech to Text conversion, performs Text Translation from source language to target language, and then performs Text to Speech translation, but without consideration as to how the text-to-speech is pronounced, thus resulting in generic- or even robotic-sounding speech output. Some conventional techniques also attempt to customize output speech in an automated translation from a source language to a target language by detecting a user’s native language and accent, determining difficult-to-pronounce phonemes, translating the source language into the target language, and then using a synonym database to replace word strings that contain phonemes which are in the user’s set of difficult-to-pronounce phonemes. Nevertheless, with these conventional approaches, there remains a mismatch between the speaker and the generic- or even robotic-sounding speech output heard by the listener. Additionally, for cloud based translation techniques, performance of translation in the cloud is rife with security issues, providing malicious parties with a variety of opportunities to acquire translation and/or voice data that can then be used along with artificial intelligence to impersonate a voice of a person for nefarious purposes.

As further discussed herein below, various inventive principles and combinations thereof are advantageously employed to support audio and language translation. As used herein, the phrase “language translation” refers to a translation from one language to another language; however, with conventional approaches the resulting translation may be spoken in a robotic voice or a generically trained voice. What is particularly lacking from conventional approaches is an “audio translation,” where the resulting translation incorporates the speaker’s unique vocal character which is exhibited when speaking the speaker’s own native language.

The described techniques allow a participant in a meeting to speak in their own native language while other meeting participants hear the speech in their respective different native languages and, notably, sounding as if the speech was uniquely spoken by the speaker with the speaker’s unique vocal character. Techniques discussed herein can enable runtime audio and language translation using, for example, a client device, to increase security, to increase speed, and to adapt to speaker and listener preferences.

In one or more implementations, computing devices in networked communication, optionally via a meeting server, perform both language translation from the speaker’s native language into the listener’s native language and audio translation using the speaker’s unique pronunciation characteristics superimposed on the listener’s native language. This is performed in near real-time to enable a listener to perceive and understand communications in the listener’s native language but exhibiting the speaker’s unique vocal character (heard when the speaker speaks in their native language), thus reducing communication barriers. This empowers and promotes individuals, for example those participating in a meeting, to listen and speak in their respective native languages. In one or more implementations, a speaker trained pronunciation model, which superimposes the speaker’s own pronunciation characteristics onto the translation in the listener’s native language, is trained by a speaker speaking the speaker’s native language. In at least one implementation, at least the audio translation (as contrasts with the language-to-language translation) is performed locally on the speaker’s own computing device and remains on the speaker’s own computing device. The local storage of the speaker trained pronunciation model and performance of the audio translation locally provides an aspect of data security that is less susceptible to compromise by malicious actors. In at least one implementation, an accelerated processing unit on the speaker’s computing device may be used to perform the language and/or audio translation, to achieve light-weight, near real-time communication, which may be streamed without perceptible lag. In one or more implementations, the model trained to mimic the pronunciation characteristics that contribute to the speaker’s unique vocal character, and the translated audio data which sounds like the speaker, are protected from being imitated.

Accordingly, techniques discussed herein enable cross collaboration, such as may happen in a meeting, which may use an online meeting client, when participants may have different preferred native languages, by empowering participants to speak in their own native language without needing to translate into another language which may be difficult to understand. Communications becomes more effective when each participant can listen in their own native language which is not in a robotic, automated voice, but rather the words which are heard in the listener’s language are spoken the way the speaker would pronounce words when speaking the speaker’s own native language. Communication may also become easier as the participants can each speak in their own different native languages, between speaker and listener(s) the speech is translated to each of the listener’s own native languages and the words sound as if uniquely spoken by the speaker. Each of the participants may hear the speaker’s voice, but speaking the listener’s native language. Thus, communication barriers are reduced and communication becomes easier for the meeting participants to follow.

Notably, the described techniques also improve data security in relation to conventional real-time translation approaches which translate and/or attempt to mimic a speaker’s voice by using the computing resources at a remote server device. Communications directed through an intermediate point such as a server present a data security risk if the server maintains a model to mimic how a meeting participant speaks, because with acquisition of the model the voice of a speaker could be imitated, perhaps for nefarious purposes. With the advancement of graphics procession units (GPU), local computers may perform the necessary computations for audio and language translation at sufficient speed for meeting participation. Thus, a model of the speaker’s pronunciation characteristics, which may be a type of machine learning model, may be deployed onto a client itself on a local computer, e.g., at a client device associated with the speaker. Alternatively or additionally, such models may be embedded in a meeting client executing on a local computing device. Consequently, the data which enables audio translation of the unique vocal character of a user when speaking may be trained and maintained locally with the speaker on their local computer. It is unnecessary to provide audio translation between computing devices as it is the speaker’s own computing device that performed the audio translation. Data security can be provided because the model that enables audio translation is never moved to or present on the remote server.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

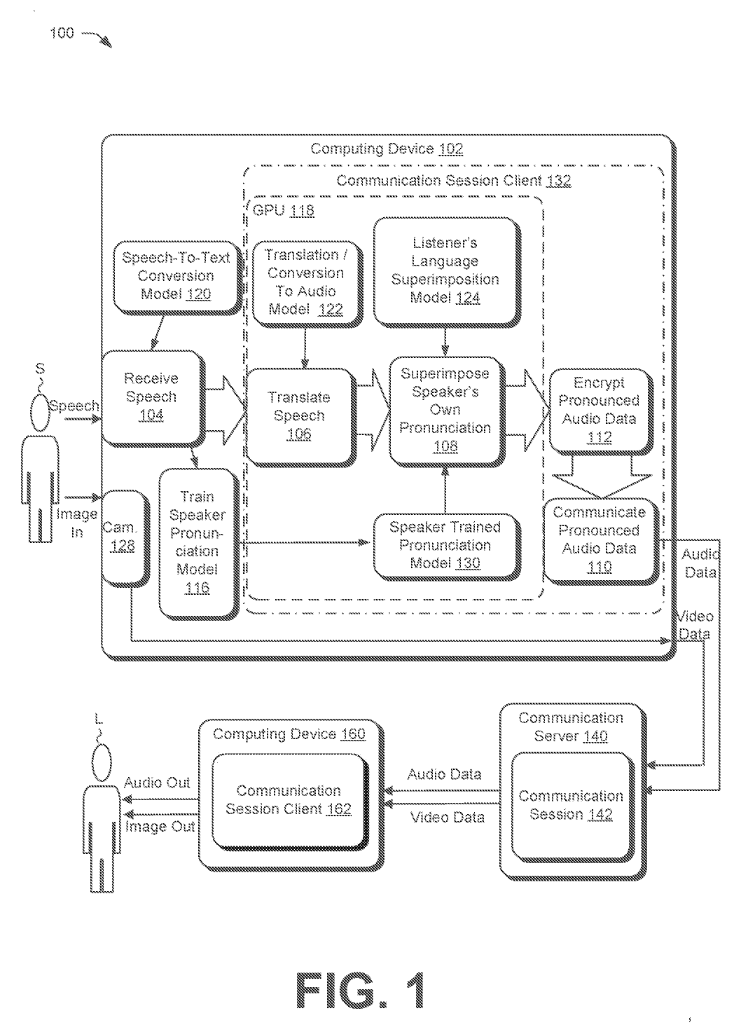

FIG. 1 is an illustration of an environment in an example implementation that is operable to employ techniques described herein. As illustrated in FIG. 1, an example audio and language translation system 100 includes a first computing device 102, a communication server 140, and a second computing device 160. In one or more implementations, the first computing device 102, the communication server 140, and the second computing device 160 are communicatively coupled, one to another, for example, over one or more networks.

In at least one implementation, at least a portion of the audio and language translation is implemented by an application such as a communication session client 132 on the first computing device 102 and/or using various resources of the first computing device 102, such as hardware resources, an operating system, firmware, and so forth. Alternatively or additionally, a portion of the audio and language translation may be implemented by an application on the second computing device 160 which may also include a communication session client 162. Alternatively or additionally, at least a portion of the audio and language translation may be implemented by resources (for example, server-based storage, processing, and so on) of the communication server 140. Alternatively or additionally, at least a portion of the audio and language translation is implemented using a third-party service, such as a meeting platform that provides one or more hardware and/or other computing resources to support provision of meeting services by web service providers, represented in FIG. 1 by a communication session 142 executing on the communication server 140.

In the illustrated environment, a speaker S utilizing the first computing device 102 and a listener L utilizing the second computing device 160 are communicating with each other, for example, participating in a meeting implemented on the communication server 140 which hosts the communication session 142. For simplicity, the present example describes the speaker S as providing the speech in the speaker’s language, which is provided to a listener L as audio output in the listener’s language with the pronunciation of the speaker. It will be understood that the communication, though illustrated in FIG. 1 as one direction, in one or more implementations occurs in both directions. It will also be understood, in one or more implementations, that the second computing device 160 could include components analogous to those of the first computing device 102 such that the second computing device 160 is also configured to support audio and language translation from the listener’s language to that of the speaker.

The first computing device 102 receives speech from the speaker S, provided in the speaker’s voice, such as via a microphone or some other system capable of capturing sound. That is, the speaker S utters the speech in the speaker’s language as Speech into the first computing device 102. The speech that is received by the first computing device 102 is converted by the first computing device 102 to audio data appropriate for communication over the network, and the audio data is communicated over the network, for example to the communication server 140. In some implementations, the speaker S is also imaged for example by a camera 128 while speaking and the images are received as Image In to the first computing device 102. The Image In is converted by the first computing device 102 to video data appropriate for communication over the network, and the video data is communicated over the network with the audio data (e.g., synchronously), for example, to the communication server 140.

In the illustrated environment, the audio data, and the video data if provided, are communicated to the communication server 140 which may be hosting the communication session 142. The communication server 140 may manage the forwarding of the audio data, and the video data if provided, for example, to computing devices represented by the second computing device 160, which are configured to play or otherwise output the audio data as Audio Out, and are configured to display or otherwise output images as Image Out from the video data if provided.

In at least one implementation, the computing devices herein represented by the first computing device 102 and the second computing device 160, are registered as participating in the meeting which may be hosted by the communication session 142 executing on the communication server 140 which enables forwarding of the audio data and the video data between the computing devices registered as meeting participants. In the illustrated example, the communication server 140 provides the audio data and, if applicable, the video data, to the second computing device 160, which outputs the audio data as the audio output and, if applicable, outputs the video data as the image output, such that the listener L may listen to the audio output and, if applicable, the image output, played by the second computing device 160.

The speech which is input to the first computing device 102 undergoes various transformations to accomplish the audio and language translation including the speaker’s pronunciation, prior to being communicated from the first computing device 102.

By way of example, the first computing device 102 receives 104 the speech in the language of the speaker and converts the speech to text. In one or more implementations, this is accomplished with a speech-to-text conversion model 120 in the speaker’s language, e.g., that receives speech in the speaker’s language as input and outputs the speech as text also in the speaker’s language. The computing device 102 may translate 106 the speech in the speaker’s language including to convert text from the speaker’s language into audio in the listener’s language. In at least one implementation, this is accomplished with a translation/conversion to audio model 122 that translates the speaker’s language to the listener’s language, such as by translating the text of the speaker’s language into text of the listener’s language. The speech, having been translated into the listener’s language, may be appropriate for creating audio that can be listened to. However, if the translated data corresponding to the speech is used to create the audio output, such translated speech may have a generic pronunciation.

In accordance with the described techniques, the computing device 102 further superimposes 108 the speaker’s own pronunciation onto the translated data in the listener’s language. This is done by utilizing a listener’s language superimposition model 124 which models the generic pronunciation of the listener’s language together and also by utilizing a speaker trained pronunciation model 130. The speaker trained pronunciation model 130 has been trained 116 on the speaker’s voice speaking in the speaker’s language to emulate the pronunciation characteristics of the speaker’s voice which the model is configured to impose onto, to modify or replace, components of the generic pronunciation. Further, the first computing device 102 communicates 110 pronounced audio data from the first computing device 102 to the second computing device 160, for example via the communication server 140. Thus, the speech which is received by the first computing device 102 in the speaker’s language is output by the first computing device 102 as pronounced audio data in the listener’s language. The pronounced audio data includes the speaker’s own pronunciation characteristics on the speech in the listener’s language and thus exhibits the speaker’s unique vocal character.

Implementations of the audio and language translation can provide security aspects. According to one aspect, for instance, the speaker trained pronunciation model 130 may remain solely stored locally on the first computing device 102, so that the speaker’s vocal character cannot be imitated from the speaker trained pronunciation model 130 and used for nefarious purposes. According to another aspect, the communication of data from the first computing device 102, to the communication server 140, and/or to the second computing device 160 may be encrypted. Thereby, even if someone in the middle tries to read a message in a confidential meeting, the audio data would be protected by being encrypted thus maintaining confidentiality. As another aspect, a model such as the speaker trained pronunciation model 130 may be encrypted at its local storage location. Further, a decryption key may be specific to the computing device on which the speaker trained pronunciation model 130 is stored, in this example, the first computing device 102. Thus, only the first computing device may be able to decrypt the speaker trained pronunciation model 130 when encrypted. Therefore, there is no way for a bad actor, even if the first computing device 102 is hacked, to extract the data or model weights which may be embedded in the speaker trained pronunciation model 130 and thus the bad actor is prevented from using the model to replicate the user’s voice.

Once the speaker’s own pronunciation is superimposed onto the translated language, the audio data stream to the second computing device 160 may also be encrypted. Accordingly, the communications to and from the server are encrypted, and may be decrypted by any of the communication session clients 132, 162, or the communication server 140, and no one else. All the data regarding a speaker’s speech, vocal character, dialects, model inputs, and/or model weights which enable the speaker trained pronunciation model 130 to superimpose the pronunciation characteristics of the speaker, is encrypted. In one or more implementations, all such data can only be utilized by decrypting the model(s) that are locally on the computing device and no other. In one or more implementations, the first computing device 102 encrypts 112 the pronounced audio data prior to being communicated from the first computing device 102.

One or more of the components that perform one or more of the described operations, such as to receive 104 speech in the speaker’s language, translate 106 the speech into the listeners’ language, and superimpose 108 the speaker’s own pronunciation onto translated data, and some or all of the models, for example the speech-to-text conversion model 120, the translation/conversion to audio model 122, the listener’s language superimposition model 124, and the speaker trained pronunciation model 130, together may be considered an engine. Such an engine, on the first computing device 102, may translate the speaker’s native speech into audio data comprising speech in the listener’s native language, and then communicate that audio data (e.g., encrypted) across the network to the second computing device 160, possibly through a server, here represented by the communication server 140. In at least one implementation, the engine on the first computing device 102 may be responsible for performing both the audio and language translation, and then sending the manipulated data over the network; the communication server 140 then sends the manipulated data to the second computing device 160 from the first computing device 102.

The audio and language translation can be performed using lightweight federated models on the first computing device 102, which may be referred to as a client side. The models may be referred to as “lightweight” or “heavy”. A heavy model is relatively large in size; the bigger the model, the more time it takes to produce an output; the smaller the model, the faster it can produce an output. The models discussed herein are preferably lightweight, meaning containing limited data or trained on limited data, so that within a matter of milliseconds, the output is provided. If the delay is even seconds, then there can be a noticeable lag in communication between the listener and the speaker, which detracts from the real-time meeting experience. In some implementations, the models discussed herein, for example those on the first computing device, are lightweight. The models may be referred to as “federated” which means that the functions are performed on the client side, that is, each computing device includes its own respective models and components to perform audio and language translation locally. In at least one implementation, another aspect of a “federated model” is that the federated model may be gradually trained over time. In an implementation, one or more such models may be improved when used, thus providing a learning aspect. For example, the speaker trained pronunciation model 130 may continually use audio samples that are spoken into the audio and language translation system, such as when the computing device 102 receives 104 speech, to train itself repeatedly to extract and refine pitch, timbre and amplitude factors, thereby continuously refining the ability of the speaker trained pronunciation model 130 to superimpose those factors onto the translated speech.

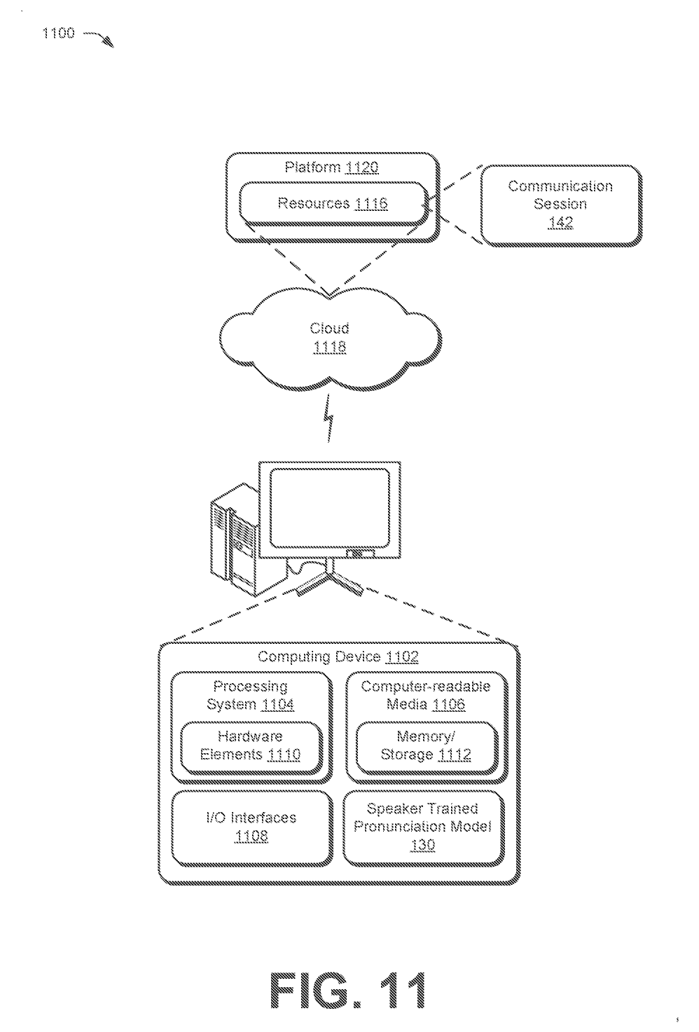

Computing devices that implement the audio and language translation system 100 are configurable in a variety of ways. A computing device, for instance, is configurable as a desktop computer, a laptop computer, a mobile device (for example, assuming a handheld configuration such as a tablet or mobile phone), an IoT device, a wearable device (for example, a smart watch, a ring, or smart glasses), an AR/VR device (for example, the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm utilized to perform operations “over the cloud” as further described in relation to FIG. 11.

In the illustrated example, the processor resources of the first computing device 102 include an accelerated processing unit, represented in the illustration by a graphics processing unit (GPU) 118, which supports compute-intensive tasks, for example, as encountered in machine learning and deep learning where training can involve massive parallelism and repetitive calculations, such as in connection with matrix multiplication and element-wise operations.

In at least one implementation, tasks which are executed by the GPU 118 include to translate 106 speech into the listener’s language, and to superimpose 108 the speaker’s own pronunciation onto the translated data, as well as training and utilizing the described models such as the translation/conversion model 122, the listener’s language superimposition model 124, and/or the speaker trained pronunciation model 130. However, one or more, or all, or none, of the features illustrated in FIG. 1 as implemented on the first computing device 102, may be executed by the GPU 118.

In at least one implementation, the communication session client 132, 162 supports communication of data across various network(s) between the computing devices (e.g., the Internet), represented by the first computing device 102 and the second computing device 160, and the communication server 140, such as in connection with a communication session 142 executing on the communication server 140.

Having considered an example of an environment, consider now a discussion of some example details of the techniques for audio and language translation between computing devices in accordance with one or more implementations.

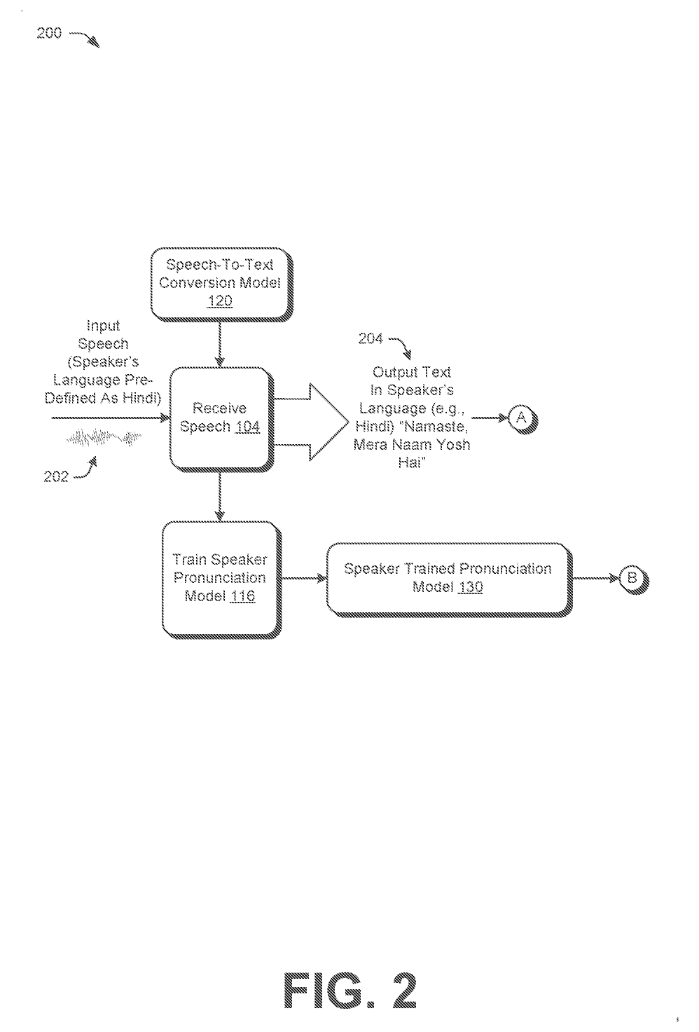

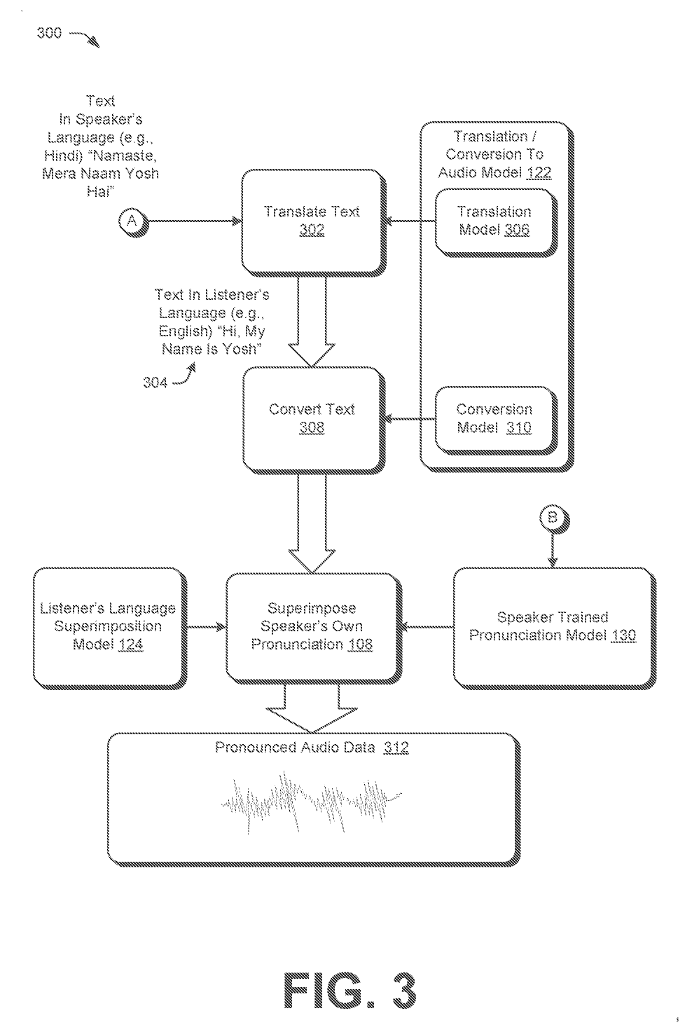

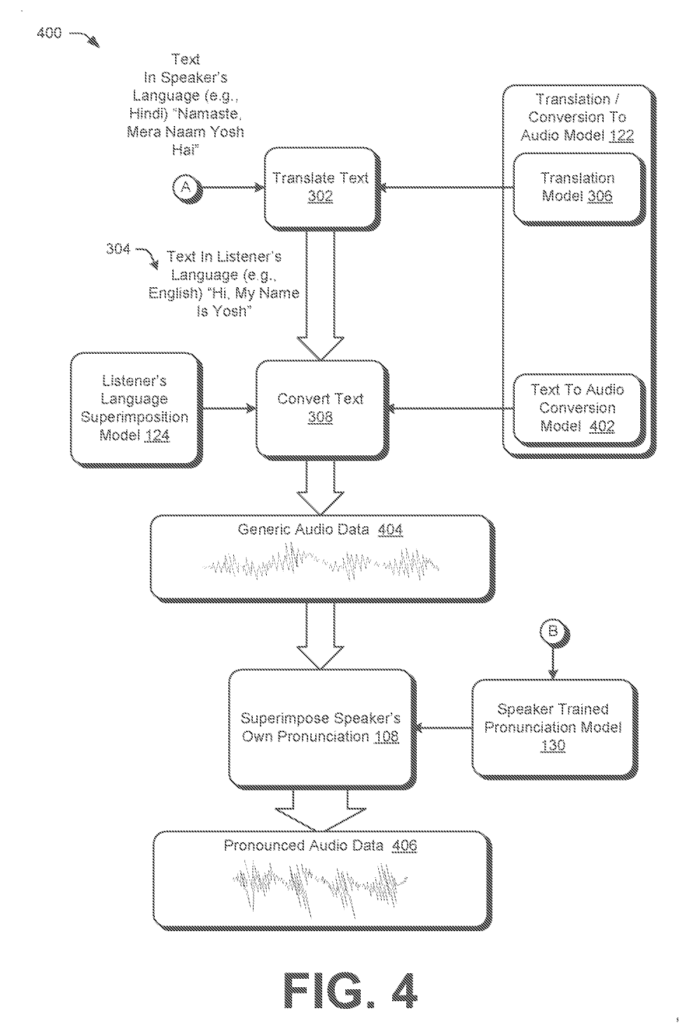

FIG. 2, FIG. 3, and FIG. 4 illustrate concepts of some implementations and variations thereof relating to the audio and language translation, from an input of speech which is in the speaker’s voice to the pronounced audio data which is output over the network as translated speech in the speaker’s voice. The input speech is translated to the listener’s language and output, in the speaker’s voice, such that the speaker’s vocal character including tone, pronunciation, and dialect is maintained.

FIG. 2 illustrates one example from the input of speech to the output of text in the speaker’s language and covers an implementation of training on the speaker’s voice. FIG. 3 and FIG. 4 are alternatives to teach other and illustrate receiving text of the speech in the speaker’s language and providing the pronounced audio data in the listener’s language, but with the speaker’s unique vocal character. In FIG. 2, FIG. 3 and FIG. 4, an example in which the speaker’s language is Hindi and the listener’s language is English is discussed, although the principles may be applied to any languages.

The speaker’s language may be pre-defined, for example, prior to beginning the audio and language translation, such as by a speaker selecting their native language in settings of a communication client or a program (e.g., the communication client) detecting the speaker’s native language. As noted above, in the examples discussed through FIG. 2, FIG. 3 and FIG. 4, the speaker’s language may be pre-defined as Hindi. It is possible that the speaker’s language and/or the listener’s language may be pre-defined at any of a variety of times, such as prior to beginning training of the speaker pronunciation model, after being detected, as part of the communication, as part of joining the meeting, and/or as part of a registration process in connection with an on-line meeting log-in or registration process, for example.

FIG. 2 illustrates an example 200 of one or more portions of audio and language translation between computing devices. Input speech 202, which is voiced by a speaker as represented in FIG. 2 by sound waves, is received 104, for example via a microphone associated with the computing device 102, in the speaker’s language. In this example, the input speech 202, in the speaker’s language, is converted using a speech-to-text conversion model 120 that models how to convert speech from the speaker’s language into text in the speaker’s language. Text of the speech in the speaker’s language is output at connector A. In the example of FIG. 2, this output text 204 is “Namaste, mera naam Yosh hai.” Thus, the input speech 202 as captured audio has been processed and converted into text of the speech in the speaker’s language. A corresponding connector A is illustrated in FIG. 3 and FIG. 4, which are alternatives to each other.

FIG. 2 further illustrates the training 116 of the speaker trained pronunciation model 130 on the speaker’s voice in the speaker’s own language. In an initialization of the audio and language translation for the speaker, for instance, the speaker may be prompted by the computing device to speak certain pre-selected words, phrases, and/or sentences in the speaker’s language, from which the speaker trained pronunciation model 130 may be trained as to pronunciation characteristics of the speaker which are extracted from the words, phrases, and/or sentences on which the speaker trained pronunciation model 130 is trained. Alternatively, or in addition, the speaker trained pronunciation model 130 may be trained 216 in the speaker’s own language on the pronunciation characteristics extracted from words of the input speech in the speaker’s voice while actively providing the speech for audio and language translation between computing devices, such as during an actual meeting between users.

Pronunciation characteristics may include one or more of timbre, pitch, amplitude, and articulation, by way of example, and/or patterns of one or more of the foregoing, which collectively make up a person’s unique vocal character, and which tend to differ among persons, such as among persons who speak the same language. The pronunciation characteristics which are extracted from the words, phrases, and/or sentences during training may be superimposed onto the audio data so that the audio data sounds like the speaker. The speaker trained pronunciation model 130 is provided for the superimposing those pronunciation characteristics at connector B. A corresponding connector B is illustrated in FIG. 3 and FIG. 4, which are alternatives to each other. Accordingly, pronunciation characteristics exhibited in the audio examples of the speaker’s voice in the speaker’s native language, embedded in the speaker trained pronunciation model 130, are used to predict how the speaker would sound and how the speaker would pronounce words in the translated text in the listener’s language and to superimpose those pronunciation characteristics as mapped to the words, to convert the translated text which is in the listener’s language into audio in the listener’s language that has the speaker’s vocal character.

FIG. 3 and FIG. 4 further discuss alternative examples of translating the text in the speaker’s language into the listener’s language, and subjecting the translated text to an audio conversion (i.e., text-to-audio) which causes the speech to sound as if the speaker is speaking. The audio conversion uses a speaker trained pronunciation model 130 trained on the speaker’s voice, speaking the speaker’s native language. Broadly, FIG. 3 depicts an example of superimposing the speaker’s own pronunciation onto translated data in which the translated text has been converted to linguistic representations. By contrast, FIG. 4 depicts an example of superimposing the speaker’s own pronunciation onto generic audio data corresponding to the translated text.

FIG. 3 illustrates an example 300 of portions of audio and language translation between computing devices. In the illustrated example, text of the speech in the speaker’s language is received as input at connector A and is ultimately translated and converted into audio data in the listener’s language as if pronounced by the speaker.

In a given language, each sentence or each word may have different timbre, pitch, amplitude, and articulation which can be mapped. Also, breaks or intonation such as indicated by punctuation may have timbre, pitch, amplitude, and articulation which affect the pattern of adjoining words said together. Further, phrases such as parts of sentences tend to have patterns of intonation caused by pitch, amplitude, and articulation. Thus, a listener’s language superimposition model 124 of generic pronunciation would generally describe how words and/or phrases sound, for example, consider the phrases “Hi, I’m Yosh” or “I am Yosh”. In the listener’s language which is English, the words “I am” combined together in a phrase, versus “I” and “am” as two independent words, have different known pronunciation characteristics such as pitch, timbre, amplitude, and articulation. The speaker’s voice speaking the speaker’s language further has its individual pronunciation characteristics such as timbre, pitch, amplitude, and articulation, which can be detected and modeled. Accordingly, a speaker’s pronunciation characteristics can be superimposed as audio components onto the translated data in the listener’s language, so that the pronounced audio data exhibits the speaker’s unique vocal character.

At connector A, the text in the speaker’s language is translated at 302 from the speaker’s language into text in the listener’s language 304, for example, by using a translation model 306 that models text-to-text translation from the speaker’s language to the listener’s language. In the illustrated example, the text in Hindi, “Namaste, mera naam Yosh hai” is translated into text in English, “Hi, my name is Yosh”. Then, the text in the listener’s language may be, in some implementations, converted at 308 to linguistic representations, for example, using a conversion model 310 that converts text in the listener’s language to audio in the listener’s language. Such linguistic representations may indicate a generic pronunciation of the words, at least sufficient for a computer to generate audio from the text. From the linguistic representations, sentences may be understood, and generic timbre, pitch, amplitude, and/or articulation, may be mapped onto those representations by the listener’s language superimposition model 124 . Broadly, the listener’s language superimposition model 124 models generic pronunciation of words in the listener’s language, as there may be particular ways or a limited range of suitable ways to pronounce words in the listener’s language, such that if the words are pronounced such a way a native speaker would likely understand but such that if not pronounced that way, it may hamper the experience of the listener.

The speaker’s own pronunciation modeled by the speaker trained pronunciation model 130 is superimposed 108 onto the translated data by mapping the speaker’s pronunciation to the generic pronunciation modeled by the listener’s language superimposition model 124, such that the generic pronunciation of words and phrases of the listener’s language is replaced or overlaid by the speaker’s pronunciation characteristics in accordance with the speaker trained pronunciation model 130. As discussed above and below, the speaker trained pronunciation model 130 has been trained on the speaker’s voice in the speaker’s language, and the speaker trained pronunciation model 130 specifies the speaker’s unique pronunciation characteristics such as timbre, pitch, amplitude, articulation, and/or patterns of the foregoing.

For example, syllables of a word in the listener’s language may generically be specified as having a specific pitch value, a specific amplitude, and a particular timbre value when pronounced as part of that word (or as part of a phrase including the word). The speaker trained pronunciation model 130 has captured those pronunciation characteristics from the speaker’s voice through training and can superimpose 108 those pronunciation characteristics onto the corresponding generic pronunciation characteristics in the translated speech. Accordingly, the superimposition 108 changes the audio data based on, weighted by, to be replaced by, and/or to match the values in the speaker trained pronunciation model 130, such as by modifying, weighting, or replacing the generic pronunciation characteristics (timbre, pitch, amplitude, articulation, and combinations thereof) which may be present in the translated speech predicted or output by the listener’s language superimposition model 124 with the characteristics modeled by the speaker trained pronunciation model 130. Thus, the values of the speaker’s pronunciation characteristics are superimposed on top of the generic pronunciation of the words in the listener’s language/ This can be output and also communicated as pronounced audio data 312, which represents the speech in the listener’s language as if pronounced by the speaker.

Broadly, timbre may refer to a tone quality sometimes described as color or overtones. Pitch may refer to a relative highness or lowness as perceived by the ear. Amplitude may refer to how loud a sound is. Articulation may refer to how clearly sounds are produced, for example, some sounds may be slurred together or spaced apart from each other, or a sound may be dropped from a word or unique sounds may be used (by way of example but not limitation, sibilance, a rolled R). Patterns of the foregoing may occur, for example, words in a sentence may be spoken quickly, or sentences may end with a higher pitch. The foregoing are meant to be illustrative.

Once the speaker trained pronunciation model 130 is used to superimpose the speaker’s pronunciation characteristics onto the generic words, pronounced audio data 312 is produced. The pronounced audio data 312 is audio in the listener’s language sounding as if spoken by the speaker. For example, the pronounced audio data 312 incorporates the unique vocal character of the speaker as captured in the pronunciation characteristics of the speaker’s timbre (color or overtones), pitch (highness or lowness), amplitude (loudness), articulation (such as the speaker’s tendency to slur or elide or the like, or use of particular sounds), and combinations and patterns thereof.

In the continuing example, for instance, the phrase translated as “Hi, my name is Yosh” will yield audio data which will be played back and sound as if pronounced with, for example, the speaker’s timbre, pitch, amplitude, articulation, and patterns thereof. Consequently, the pronounced audio data 312 has both the audio of the translated words superimposed with the speaker’s own vocal characteristic observed in the speaker’s native language and also the content of the speech in the listener’s language. The pronounced audio data 312 can be communicated (and encrypted) between computing devices.

FIG. 4 illustrates an example 400 of portions of audio and language translation between computing devices. As in FIG. 3, the text in the speaker’s language is input and ultimately translated and converted into audio data in the listener’s language as if pronounced by the speaker. The text in the speaker’s language is received as input at connector A. The text in the speaker’s language is translated 302 from the speaker’s language into text in the listener’s language 304, for example using the translation model 306 that models translation from text in the speaker’s language to text in the listener’s language.

In the illustrated example, the text in Hindi, “Namaste, mera naam Yosh hai” is translated into text in English, “Hi, my name is Yosh”. Then, the text in the listener’s language 304 is converted 308 to generic audio, for example using a text-to-audio conversion model 402, which models conversion of text in the listener’s language to audio in the listener’s language, and the listener’s language superimposition model 124 which outputs generic pronunciations of words and phrases in the listener’s language. The illustrated example 400 includes generic audio data 404, which may represent audio sound waves, as output by the listener’s language superimposition model 124 having a robotic or averaged sound – but not the sound of the speaker. In one or more implementations, the generic audio data 404 output from the listener’s language superimposition model 124 may be the result of training the listener’s language superimposition model 124 based on the voices of other users (e.g., audio collected from many users) speaking the listener’s language.

The speaker’s own pronunciation is superimposed 408 onto the generic audio data 404 using the speaker trained pronunciation model 130, so as to replace or overlay the generic pronunciation with the speaker’s pronunciation characteristics as captured and embedded in the speaker trained pronunciation model 130, which is trained to model pronunciation characteristics of the individual speaker (and not other speakers) such as timbre, pitch, amplitude, articulation, and/or patterns of the foregoing. Accordingly, the generic audio data 404 representing the sounds, in some implementations digital representations of sound waves, is adjusted to have the speaker’s timbre as modeled by the speaker’s own pronunciation model. Additionally, the generic audio data 404 may be adjusted to have a different pitch, to include a timbre modeled by the speaker trained pronunciation model 130, to have a different amplitude (louder or softer), to have a different articulation, and/or to have various patterns of the foregoing. The generic audio data 404 in the listener’s language after modification with the speaker’s pronunciation is output as pronounced audio data 406. The pronounced audio data 406 includes the speech as translated into the listener’s language and pronounced as if spoken by the speaker, including to have the speaker’s unique vocal character. In the continuing example, the phrase translated as “Hi, my name is Yosh” yields audio data which when played back or otherwise audibly output sound as if pronounced with, for example, the speaker’s timbre, pitch, amplitude, articulation, and patterns of pronunciation. The pronounced audio data 406 can be communicated between computing device.

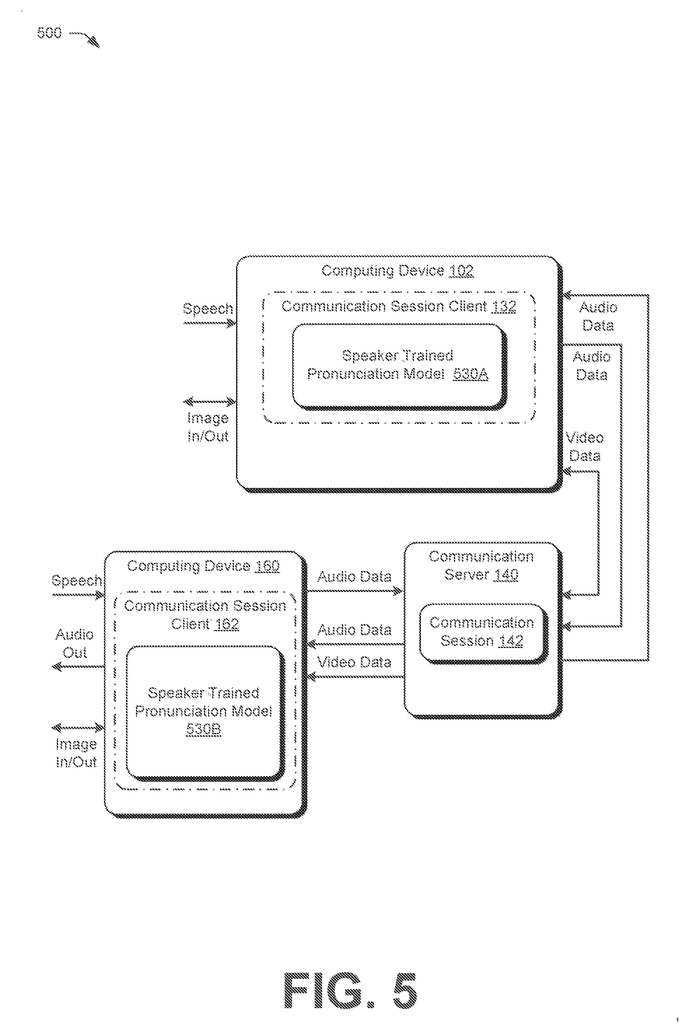

FIG. 5 illustrates another example of audio and language translation between computing devices. In the illustrated example, an audio and language translation system 500 includes a first computing device 102 executing a communication session client 132, a second computing device 160 executing a communication session client 162, and a communication server 140 executing a communication session 142. In this example, both computing devices include a speaker trained pronunciation model 530A, 530B, and audio data is shown as communicated in both directions.

The first computing device 102 includes a speaker trained pronunciation model 530A trained on the speaker’s voice in the speaker’s language; the speaker’s language may be predefined for the first computing device 102. The second computing device 160 also includes a speaker trained pronunciation model 530B trained on the speaker’s voice in the speaker’s language; the speaker’s language may be predefined for the second computing device 160. Speech is received by the first computing device 102 and by the second computing device 160 and subjected to audio and language translation, as described above and below. In some implementations, speakers at the computing devices may be imaged and the images are input and output (e.g., Image In/Out) between the first computing device 102 and the second computing device 160 as video data and communicated over one or more networks with the audio data.

Each of the first computing device 102 and the second computing device 160 may be participants participating in a networked meeting managed or otherwise implemented by the communication session 142 in which audio data and image data is exchanged. The audio data may be pronounced audio data as discussed in detail above. The speaker trained pronunciation model 530A, which may uniquely model a pronunciation of a specific user of the first computing device 102, remains stored on the first computing device 102, so that it is not shared. Thus, the first computing device 102 maintains control over the particular pronunciation model which provides enhanced security for the user of the first computing device 102. Likewise, the speaker trained pronunciation model 530B remains stored on the second computing device 160. The speaker trained pronunciation model 530B uniquely models a pronunciation of a specific user of the second computing device 160.

A meeting relating to the first computing device 102 and the second computing device 160 may include the communication session clients 132, 162 executing on the computing devices, and may be hosted by the communication server 140. For example, in a networked meeting, the first computing device 502, the second computing device 560, and the communication server 140 may communicate via a network based on execution of the communication session client 132, 162, and of the communication session 142. In one or more scenarios, the first computing device 102 communicates data, such as audio data and video data, to the communication server 140. Using one or more known techniques, the communication server 140 sends the audio data and the video data to the second computing device 160.

In at least one scenario, when a meeting is joined, the communication session clients 132, 162 may, before the meeting starts, have a respective user input, for example, name and native language. Thus, when the meeting is joined, the language of the user of the first computing device 102 has been defined (as the user’s speaker language when participating as a speaker and as the user’s listener language when participating as a listener), such that audio data communicated to the first computing device 102 will comprise speech which has been audio and language translated to the predefined language, e.g., the listener language of the user.

By way of example, the first computing device 102 may pre-define a native language, for example, “Hindi”, as the user’s native language during the communication session. Thus, audio data from other users (e.g., a user of the second computing device 160) is to be received by the first computing device 102 in the user’s native language (e.g., in the user’s role as a listener). Accordingly, the first computing device 102 may specify to the second computing device 160 that the listener’s native language is “Hindi”. The second computing device 160 may also pre-define a native language, for example, a different native language such as “English” as the respective user’s language. Complementarily, the second computing device 160 may communicate to the first computing device 102 that the second computing device 160’s listener’s native language is “English.” As part of a meeting, for example, the first computing device 102 and the second computing device 160 may exchange their respective user’s native languages. After both the first computing device 102 and the second computing device 160 have joined the meeting, and the users are speaking, the appearance of a lapse is undesirable.

The audio and language translation is executed, for example, locally, on each of the computing devices while the respective user is speaking, and the translated and pronounced audio data is communicated, for example, streamed, in near real-time so that the delay is minimal and/or relatively imperceptible. Small delays may be incurred for the speech-to-text conversion, the text-to-text translation/conversion, the superimposition, and the communication from the first computing device 102 to the second computing device 160, plus any routing through the communication server 140.

It will be understood that the first computing device 102 and the second computing device 160 are representative of any number of computing devices, for example one, two, three, or more, which may participate in a meeting simultaneously.

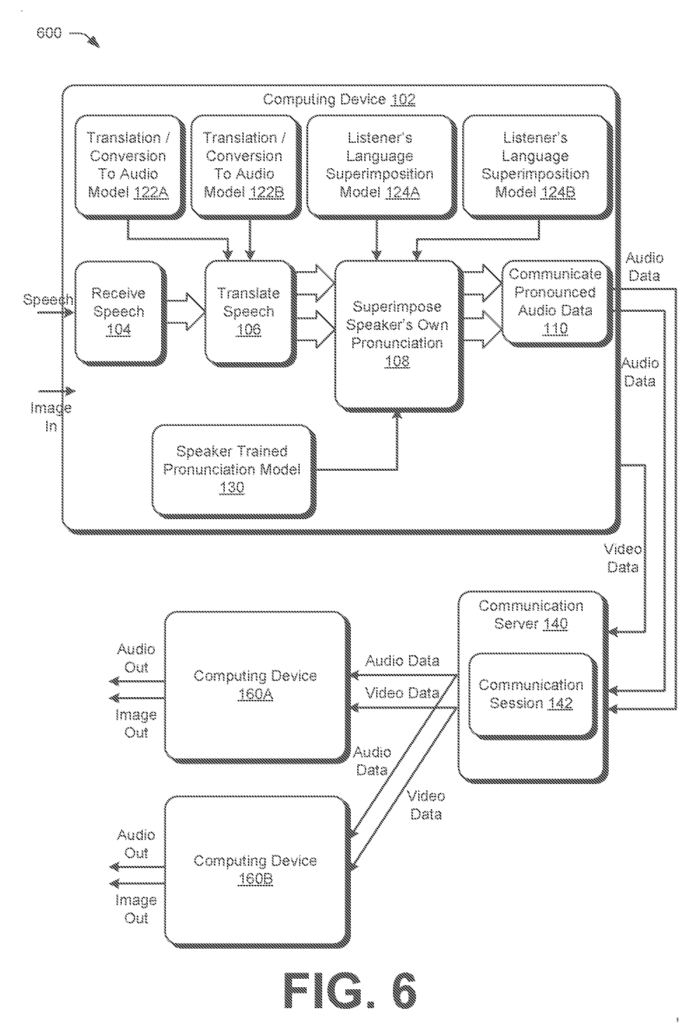

FIG. 6 illustrates another example of audio and language translation between computing devices. The following description may omit portions which have already been discussed in detail. FIG. 6 depicts an example of a group meeting between three or more participants.

In at least one variation, a group meeting can be limited to a pre-determined number of participants, for example to a maximum of three to five participants, so as to avoid overloading the computing devices which may become slower as languages are added due to the translation and superimposition of pronunciation occurring locally at the computing devices. According to another alternative, the number of languages may be limited, for example to a maximum of three-to-five languages, or five-to-ten languages, based on capabilities of the hardware of the computing devices, e.g., a throughput of their GPUs, size of memory, and so forth, so that the audio and language translation system is able to provide a near-real time experience.

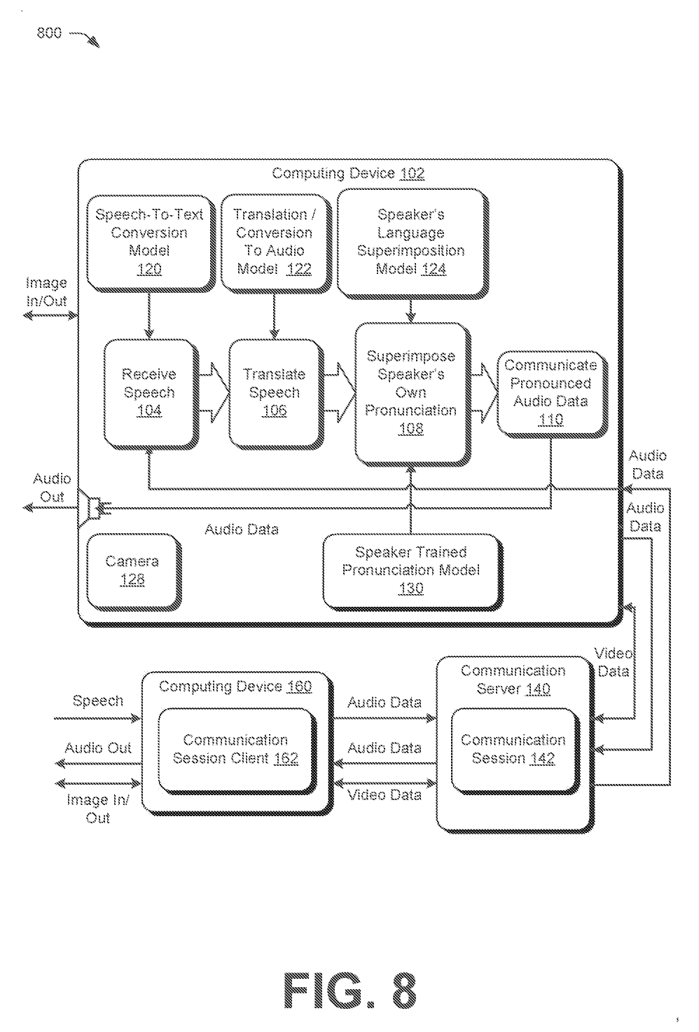

In at least one variation, for a large group call in which the speaker broadcasts to many participants – the number of which exceeds the maximum languages for the computing device – rather than have the speaker’s computing device prepare the translated data for all of the languages, the communication server may perform the translations into the different listeners’ native languages (without superimposing the speaker’s own pronunciation), and send just the translated audio to the listeners’ computing device which then perform the superimposition. Rather than superimpose the speaker’s vocal characteristics onto the translated speech, in this variation, the listener’s computing device may instead the listener’s own pronunciation model, superimposing characteristics of the listener’s voice onto the translated audio data, as further discussed in connection with FIG. 8. As a result, each of listeners hears the audio data as if listening to himself or herself talk. This approach for large groups may avoid undesirably slowing down the computing systems in group meetings, while also avoiding robotic or generic sounding audio.

In the illustrated example, an audio and language translation system 600 includes a first computing device 102 executing a communication session client 132, two second computing devices 160A, 160B, and a communication server 140 executing a communication session 142. In this example, each of the two second computing devices 160A, 160B, has a pre-defined listener’s language different from each other, and different from the pre-defined speaker’s language. The first computing device 102 may receive 104 the speech in the speaker’s language, which is converted to text in the speaker’s language. The text in the speaker’s language is then translated 106 into the listener’s language for each of the two different pre-defined listener’s languages. In other words, the text in the speaker’s language is translated 106 twice, once into a first listener’s language for the predefined language of the computing device 160A and once into a second listener’s language for the predefined language of the computing device 160B. These models for translating the speech received in the speakers language to the respective listener’s language and converting the translated speech to audio include the translation/conversion to audio models 122A, 122B, for each of the two different pre-defined listener’s languages.

Then, the speaker’s own pronunciation is superimposed 108 onto the translated audio data with the speaker trained pronunciation model 130. For example, the speaker trained pronunciation model 130 is used to superimpose vocal characteristics of the speaker onto speech translated into a first listener’s language in connection with using listener’s language superimposition model 124A and onto speech translated into a second listener’s language in connection with using listener’s language superimposition model 124B. In accordance with the described techniques, the listener’s language superimposition models produce generic pronunciation of the translated speech in a particular language, but they do not impose the speaker’s particular vocal characteristics onto the translated speech. In order to superimpose the speaker’s particular vocal characteristics, the speaker trained pronunciation model 130 is additionally utilized.

The first computing device 102 is configured to communicate 110 the pronounced audio data generated in each of the two listener’s languages to the communication server 140. In other words, in the example, two separate “streams” of audio data are provided from the computing device 102, one in a first language and another in a second language. In the illustrated example, the two streams of audio data are depicted being communicated to a corresponding second computing device 160A, 160B. The communication server 140 is capable of routing the pronounced audio data in the respective two different listener’s languages to the respective second computing device 160A, 160B. The first computing device 102 may communicate the pronounced audio data by streaming. The first computing device 102 may communicate the pronounced audio data and the video data substantially synchronously.

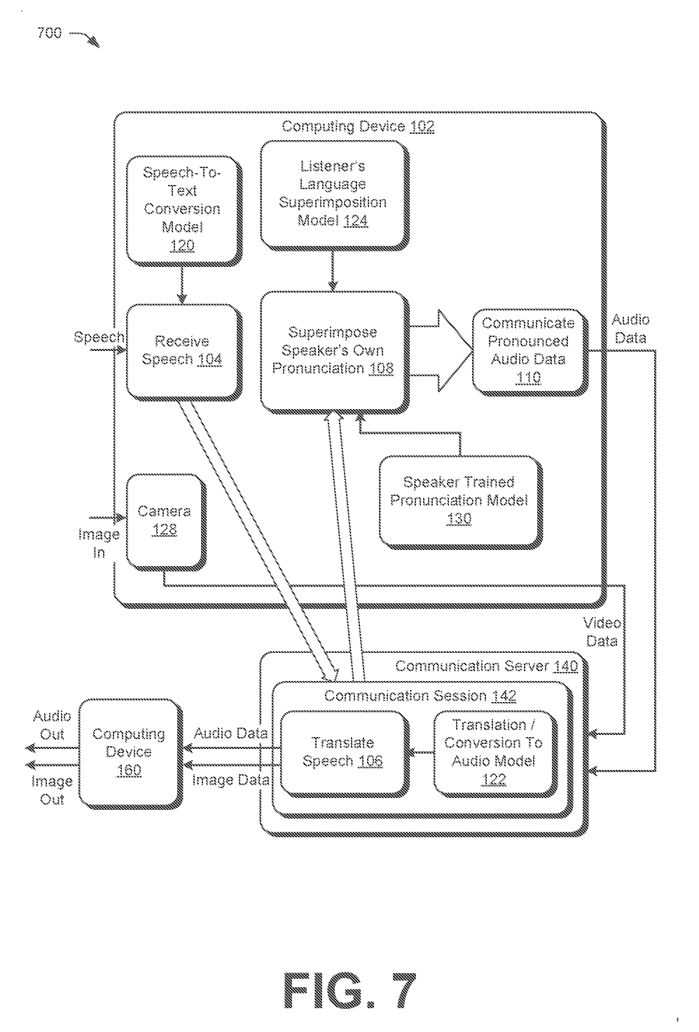

FIG. 7 illustrates another example 700 of audio and language translation between computing devices. In this example, an audio and language translation system includes a first computing device 102, a second computing device 160, and a communication server 140 executing a communication session 142. Many of the details discussed above are omitted from the following. This example differs from the previous examples in that portions of the audio and language translation, for example, to translate 106 speech from the speaker’s language into the listener’s language and the translation/conversion to audio model 122, are not provided by the first computing device and instead are provided and executed by the communication server 140.

In this manner, some of the audio and language translation processing may be offloaded from the first computing device 102 onto the communication server 140. In this illustration, the first computing device 102 receives 104 speech in the speaker’s language and converts the speech from the speaker’s language to text using a speech-to-text conversion model 120. The text in the speaker’s language is communicated to the communication server 140. At the communication server 140, the text in the speaker’s language is translated 106 from the speaker’s language into translated data in the listener’s language using the translation/conversion to audio model 122, examples of which are discussed in detail above. In additional or alternative implementations, the only model on the first computing device 102 used for the described translation and audio conversion is a speaker trained pronunciation model 130. In such an implementation, the communication server 140 may translate 106 the speech to text using the speech-to-text conversion model 120. Offloading one or more of the speech-to-text conversion model 120, the translation/conversion to audio model 122, and the listener’s language superimposition model 124 and/or one or more of the speech-to-text and the text-to-listener’s language, onto the communication server 140 may be particularly desirable where several different pre-defined listener languages are requested, as it avoids the necessity of the first computing device 102 downloading various new models corresponding to newly needed languages as users join a meeting.

The translated/converted data is communicated by the communication server 140 back to the first computing device 102. The first computing device 102 may superimpose 108 the speaker’s own pronunciation onto the translated data by using the listener’s language superimposition model 124 and the speaker trained pronunciation model 130 as discussed above, to produce pronounced audio data. The first computing device 102 is configured to then communicate 110 the pronounced audio data, with any corresponding video data captured by a camera 128 at the first computing device, to the communication server 140. The communication server 140 may forward the pronounced audio data together with any corresponding video data to the second computing device 160.

FIG. 8 illustrates another example 800 of audio and language translation between computing devices. In this example, translation to and from the speaker’s predefined language and the listener’s predefined language are provided on the first computing device 102. Portions previously discussed may be omitted from the following description.

In the illustrated example, an audio and language translation system includes a first computing device 102 executing a communication session client (not illustrated), a second computing device 160 executing a communication session client 162, and a communication server 140 executing a communication session 142. The first computing device 102 includes a speaker trained pronunciation model 130 trained on the speaker’s voice in the speaker’s language. The speaker’s language may be predefined for the first computing device 102. Each of the first computing device 102 and the second computing device 160 may be participants in a networked meeting managed by the communication session 142 in which audio data and image data (e.g., video) is exchanged. The audio data may be pronounced audio data as discussed in detail above, i.e., translated to a listener’s language but that maintains vocal characteristics of the speaker. The speaker trained pronunciation model 130, which may uniquely reflect a pronunciation of a respective user, remains stored on the first computing device 102, so that it is not shared and is not provided to other computing devices (e.g., a server) where it may be exposed to malicious attackers. The first computing device 102 maintains control over the particular pronunciation model for a user associated with the first computing device 102.

In this example, the second computing device 160 is not depicted having audio and language translation features. So that the user of the first computing device 102 may benefit from audio and language translation, the untranslated audio data from the second computing device 160 is communicated via the communication server 140 to the first computing device 102. The first computing device 102 receives 104 the untranslated audio data of the speech in the listener’s predefined language (which is assigned to the second computing device 160) and converts this speech to text using a speech-to-text conversion model 120. The text in the listener’s language is translated 106 into the speaker’s predefined language (which is assigned to the first computing device 102) using a translation/conversion to audio model 122 corresponding to the speaker’s language, and thus producing translated data. Then, the speaker’s own pronunciation is superimposed onto the translated data in accordance with the speaker’s language superimposition model 124 and the speaker trained pronunciation model 130 trained on the speaker’s voice in the speaker’s language.

The pronounced audio data, which is in the speaker’s language with the speaker’s pronunciation, is communicated 110, for example, by being played as audio output at the first computing device 102. The audio which is provided to the first computing device, to be heard by the user of the first computing device, then has the pronunciation of the user of the first computing device 102. This emulation of the sound of talking to oneself may be preferable to a generic or robotic sounding translation.

Alternatively, the second computing device 160 may include a speaker trained pronunciation model (not illustrated), but due to limited capabilities, receiving 104 the speech and converting it to text, utilizing the translation/conversion to audio model 122, and superimposing pronunciation may instead be performed at the listener’s computing device, for example at the first computing device 102. As the superimposition 108 occurs at the listener’s computing device, in this example the first computing device 102, it is the speaker trained pronunciation model 130, trained with the voice of the user of the first computing device 102, which is superimposed on the generic translated speech. This may emulate the sound of talking to oneself. However, that may be preferable to listening to a generic or robotic sounding translation, or the excessively slow processing as may be encountered in a meeting involving more than a maximum number of different languages, for example, more than ten, or more than five (depending on computing device capabilities).

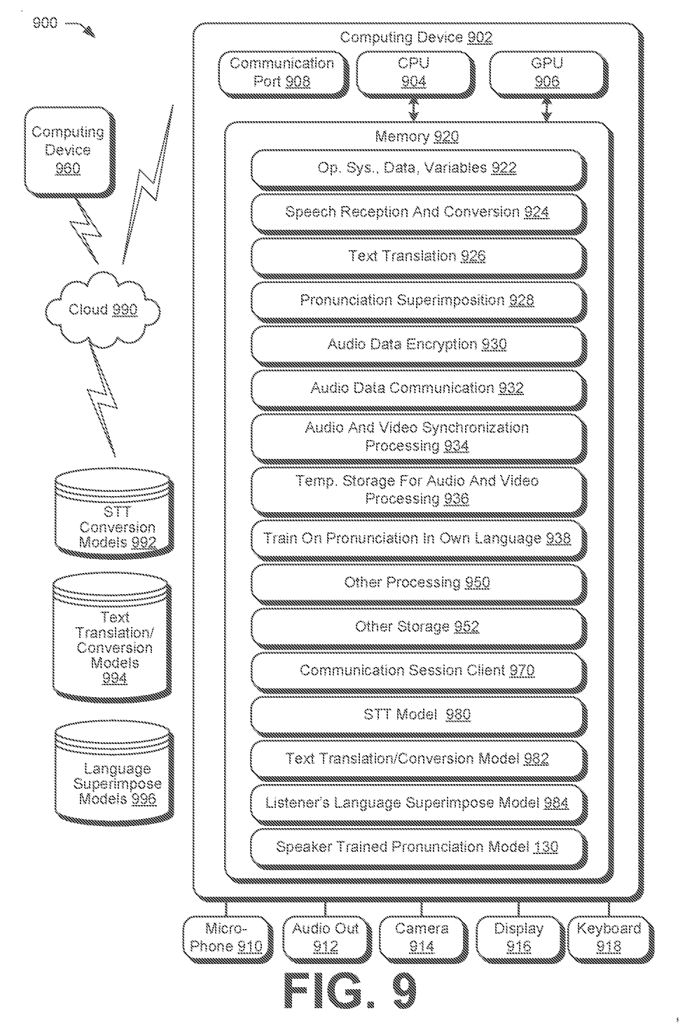

FIG. 9 illustrates portions of an example 900 of a computing device 902 arranged for audio and language translation between computing devices. The computing device 902 may include a processor including one or more microprocessors and/or one or more digital signal processors and/or one or more accelerated processing units, represented in this example by a central processing unit (CPU) 904 and a graphics processing unit (GPU) 906, a communication port 908 for communication over a network (represented by cloud 990), a microphone 910, an audio out 912, a camera 914, a display 916, a user input device such as a keyboard 918, and a memory 920. The memory 920 may be coupled to the processor and may comprise for example a read-only memory (ROM), a random-access memory (RAM), a programmable ROM (PROM), flash memory, and/or an electrically erasable read-only memory (EEPROM), and variations thereof. The memory 920 may include multiple memory locations for storing, among other things, an operating system, data and variables 922 for programs executed by the processor; computer programs for causing the processor to operate in connection with various functions such as speech reception and conversion 924 to text, text translation 926 from speaker’s language to listener’s language, pronunciation superimposition 928, audio data encryption 930, audio data communication 932, audio and video synchronization 934, training 938 the speaker pronunciation model; temporary storage 936 for audio and/or video processing, a communication session client 970; and/or other processing 950; storage for models used for audio and language translation such as a speech-to-text model (STT) 980, a text translation/conversion model 982 for translating and converting to audio, a listener’s language superimposition model 984, and a speaker trained pronunciation model 130; and a storage 952 for other information used by the processor. The computer programs may be stored, for example, in ROM or PROM and may direct a processor in controlling the operation of the computing device 102.

The microphone 910 may detect sounds and input audio to the processor in accordance with known techniques. The display 916 may present information to the user by way of a conventional liquid crystal display (LCD) or other visual display as is known, and/or the audio out 912 may play out audible signals by way of a conventional audible device (for example, a speaker).

The user may invoke functions accessible through the user input device, represented by the keyboard 918. The user input device may include one or more of various known input devices, such as the keyboard 918, a keypad, a computer mouse, a touchpad, a touch screen, and/or a trackball, to name just a few.

Responsive to signaling from the user input device represented by the keyboard 918 and/or from the microphone 910 and/or from the camera 914, in accordance with instructions stored in the memory 920, or automatically upon receipt of certain information via the communication port 908, the processor may initiate or manage functions provided by computer-executable program instructions. The functions caused by the computer-executable program instructions are detailed further below, in addition to what has been described above.

The processor may be programmed for speech reception and conversion 924 to text, for example utilizing the speech-to-text model 980. A processor may obtain the speech-to-text model 980 from the cloud 990, such as from a remote storage of speech-to-text (STT) conversion models 992 for one or more different languages. The speech-to-text model 980 which is retrieved and then stored at the computing device 102 may be acquired in correspondence to a speaker’s language which is pre-defined. Techniques for speech-to-text, sometimes referred to as automatic speech recognition or computer speech recognition, are known.

The processor may be programmed for text translation 926 from the speaker’s language to the listener’s language, for example using the text translation/conversion model 982 for translating and converting to audio. The processor may obtain the text translation/conversion model 982 from the cloud 990, such as by downloading from a remote storage of text translation/conversion models 994 for translation between a source language and a target language, for one or more combinations of source and target languages. The text translation/conversion model 982 which is retrieved and then stored at the computing device 102 may be acquired in correspondence with the speaker’s language which is pre-defined, as a source language, and to a listener’s language which is pre-defined, as a target language. Techniques are known for text-to-text translation (source language to target language), for text-to-speech conversion (same language), and for text-to-speech conversion (source language to target language), for example. Techniques are known which may synthesize text into data appropriate for being played, such as from an audio out 912. Techniques are known and continue to be developed to convert text into linguistic representations, for example which represent phonetic units which can be pronounced, for example text-to-phoneme conversion and grapheme-to-phoneme conversion. By way of illustration and not limitation, such converted text may be synthesized into speech to be output as sound. In some approaches, a back-end of text translation/conversion may impose pitch contour and phoneme durations, as examples of timbre, pitch, amplitude, and articulation, onto the sound. Such text translation/conversion generates a sound which is generic though. That is, the generated audio may sound robotic, or may have been trained using one or more voices and thus is not specific to a speaker using the computing device 102.

Further, in one or more implementations, the described system can adjust for accents within the same language, for example, United States English vs. United Kingdom English vs. Irish English vs. Indian English. In at least one variation, upon specifying a language such as when joining a meeting, if the language such as English has dialects, the listener may be prompted as to which local dialect, for example, United Kingdom English, so that the listener may hear a British accent on the English text, which may be easier for the listener to follow. The language superimposition models 996 may provide the adaptation to the local dialect, such as United Kingdom for the translated English. If a listener specifies that their language is Irish English, the speech in the speaker’s language is translated (for example, Hindi to Irish English) and would have a robotic Irish English voice, onto which the speaker’s vocal characteristics (extracted from speaking in Hindi) are superimposed and sent to the listener.

The processor may be programmed for pronunciation superimposition 928, utilizing for example the listener’s language superimposition model 984 and the speaker trained pronunciation model 130. Example techniques for performing this function have been discussed above. Examples of the listener’s language superimposition model 984 have been discussed above. The listener’s language superimposition model 984 stored at the computing device 102 may have been acquired, for example from the cloud 990, such as from a remote storage of language superimposition models 996 each corresponding to a different language and modeling a generic pronunciation.

As discussed above, the speaker trained pronunciation model 130 has been trained to correspond uniquely to the speaker and through the training is able to emulate (e.g., predict) particular pronunciation characteristics of the speaker. The unique pronunciation characteristics may be collected to correspond to phonetics which can be superimposed in connection with principles of the language superimposition models 996. The translated data on which the particular pronunciation of the speaker is superimposed is referred to as pronounced audio data.

The processor may be programmed for audio data encryption 930. A variety of techniques are generally known for encryption of data, and more or constantly being developed. In one or more implementations, the pronounced audio data, may be encrypted, to yield encrypted pronounced audio data. The encrypted pronounced audio data may then be transmitted from the computing device, for example, over the communication port 908 and then via to the cloud 990, for receipt by one or more other computing devices 960.

The processor may be programmed for the audio data communication 932. Techniques are known for communicating audio data from a computing device, for example including preparing audio data for transmission, and then transmitting the audio data from the communication port 908, such as via the cloud 990 for receipt by one or more other computing devices 960. In at least one variation, the audio data communication 932 may route the communication to the one or more other computing devices 960 corresponding to a listener. Alternatively or additionally, the audio data communication 932 may route the communication to a server which further communicates to one or more other computing devices 960. In one or more implementations, such other computing devices 960 may be registered, such as when participating in a communication session, and thus may be supported by the communication session client 970.

The processor may be programmed for audio and video synchronization 934. In one or more implementations, the speech is received as part of a video meeting in which a camera 914 captures and streams images of the speaker and/or listener in coordination with receiving audio via the microphone 910, in accordance with known techniques. The pronounced audio data which is prepared for communication may be synchronized with the video and transmitted over the communication port 908. The pronounced audio data, and the video if provided, may be streamed substantially simultaneously as the speaker is speaking, to provide a near-\ real-time meeting experience between the speaker and one or more listeners.

The processor may be programmed for training 938 the speaker trained pronunciation model 130. The speaker trained pronunciation model 130 may be trained by prompting the speaker to speak predetermined words and/or phrases in the speaker’s own language so as to obtain predetermined components of the speaker’s unique vocal character, more particularly the speaker’s unique pronunciation characteristics, for example, timbre, pitch, amplitude, and/or articulation, and patterns thereof. Alternatively or in addition, the speaker trained pronunciation model 130 may be trained while speech is being received in the speaker’s language and the pronunciation is fed forward for superimposition on the corresponding translated data in the listener’s language. The training 938 of the speaker pronunciation model using the speaker’s pronunciation extracted or detected from speech in the speaker’s language differs from known pronunciation models which store how certain words sound in the target language and require large amounts of storage.

Audio translation which superimposes a speaker’s unique pronunciation on translated speech may happen directly on the translated text using inventive techniques described herein, in which it is unnecessary for the speaker to provide speech samples in the listener’s language. In accordance with the described techniques, the listener’s language superimposition model 984 models how words in a listener’s language are pronounced, and for example, includes linguistic indicators which indicate to how words are pronounced generically. The computing device 902 adds the speaker’s unique voice to the translated data with the pronunciation characteristics captured in the speaker trained pronunciation model 130, so that it seems like the speaker is actually speaking in the listener’s language.

The computing device 902 is configured to train 938 the personalized speaker trained pronunciation model using the speaker’s pronunciations as captured from speech in the speaker’s own language, for example, from speech collected over the microphone 910. From such audio, the computing device 902 may extract the speaker’s pronunciation characteristics, here exemplified as the timbre of the speaker’s voice, the pitch of the speaker’s voice, the amplitude of the speaker’s voice, the speaker’s articulation, and combinations and patterns thereof, which are embedded in the speaker trained pronunciation model 130 based on the training.

In at least one implementation, for the speaker trained pronunciation model 130 to be at least minimally trained, training 938 may include the computing device 102 providing one to three sentences or phrases for the user to read, or may record any sentences spoken by the user, in the user’s native language. This may provide sufficient data so that the pitch, timber, amplitude, and articulation of the speaker can be extracted from the received speech. In some implementations, a single initial session that trains 938 on pronunciation of the user’s voice is sufficient to support the audio and language translation discussed herein. Additional sessions to train 938 on pronunciation of the user’s voice may be unnecessary even when translating to multiple listener’s languages or to a newly specified listener’s language. Thereafter, the computing device may use the speaker trained pronunciation model 130 to superimpose the speaker’s pronunciation.

Broadly, the listener’s language superimposition model 984 is trained to emulate general pronunciation characteristics (the pitch, amplitude, and articulation and the like generally) of a word or phrase in a particular language. Given the general pronunciation characteristics of text in the listener’s language from this model, the computing device 102 can then superimpose the corresponding vocal characteristics, such as pitch, amplitude and the like, onto those pronunciation characteristics, as modeled by the speaker trained pronunciation model 130, so it will seem like the speaker is speaking the listener’s language. The pronunciation characteristics of pitch, timbre, and amplitude can uniquely make up the vocal character of a particular person speaking, and can be superimposed onto a different language. By comparison, a conventional model developed from eliciting words which are not native to the speaker, which would be problematic itself, and then copying and pasting those sounds and combining them into speech, would result in a disconnected experience, and would still sound contrived and robotic.

Because the speaker trained pronunciation model 130 is unique to the speaker, it allows the speaker trained pronunciation model 130 not to be shared and remain stored solely on the computing device 902 of the speaker.

The processor may be programmed for temporary storage 936 used in connection with the audio and/or video processing, for example, storage while the translated data in the listener’s language has the speaker’s pronunciation imposed thereon which may be regarded as portions of the translated data being replaced or weighted.

The processor may be programmed for the communication session client 970. In one or more implementations, the computing device 902 participates in a communication, such as a networked meeting, which may be embedded in the communication session client 970 executing on the computing device 102, and a server. Two or more computing devices exemplified by computing device 902 and one or more other computing devices 960 may be registered as participants in the communication session. The communication session may coordinate, among other things, registration of participants, assignment of a listener’s predetermined language, assignment of a speaker’s predetermined language. In one or more implementations, the communication session client 970 can obtain and download, for example, one or more models from the remote storage of the speech-to-text conversion models 992 corresponding to the speaker’s predetermined language, one or more of the text translation/conversion models corresponding to the speaker’s predetermined language and the listener’s predetermined language(s), and/or one or more of the language superimposition models 996 corresponding to the listeners’ predetermined language(s). In at least one implementation, the communication session client 970 can coordinate with a server providing remote speech-to-text conversion and/or text translation/conversion.

The processor may be programmed for storage of models used for audio and language translation such as the speech-to-text model 980 for the speaker’s language, the text translation/conversion model 982 for translating and converting to audio from the speaker’s language to the listener’s language, the listener’s language superimposition model 984, and the speaker trained pronunciation model 130.

In the example illustrated in FIG. 9, a server has been omitted. As an example, a speaker could talk into the computing device 102, for example, a cellular phone, which could communicate the audio and language translation to the one or more other computing devices 960 over the cloud 990 and/or via a direct connection, e.g., Bluetooth. The one or more other computing devices 960 may be equipped similarly to the computing device 102. In a conversation between users of the computing device 102 and the one or more other computing devices 960, each speaking in their own, possibly different, respective languages, the computing device 102 and the one or more other computing devices 960 may each carry out the audio and language translation so that the respective users carry on the conversation in their own languages which have been audio and language translated at their respective computing devices 960, 902.

It should be understood that FIG. 9 is described in connection with logical groupings of functions or resources. One or more of these logical groupings may be performed by different components from one or more implementations. Likewise, functions may be grouped differently, combined, and/or augmented without parting from the scope, unless specifically stated otherwise. Similarly, the present description may discuss various collections of data and information. One or more groupings of the data or information may be omitted, distributed, combined, or augmented, and/or provided locally and/or remotely without departing from the scope, unless specifically stated otherwise herein.

Having discussed exemplary details of audio and language translation, consider now some examples of procedures to illustrate additional aspects of the techniques.

### Example Procedures

This section describes examples of procedures for audio and language translation between computing devices. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

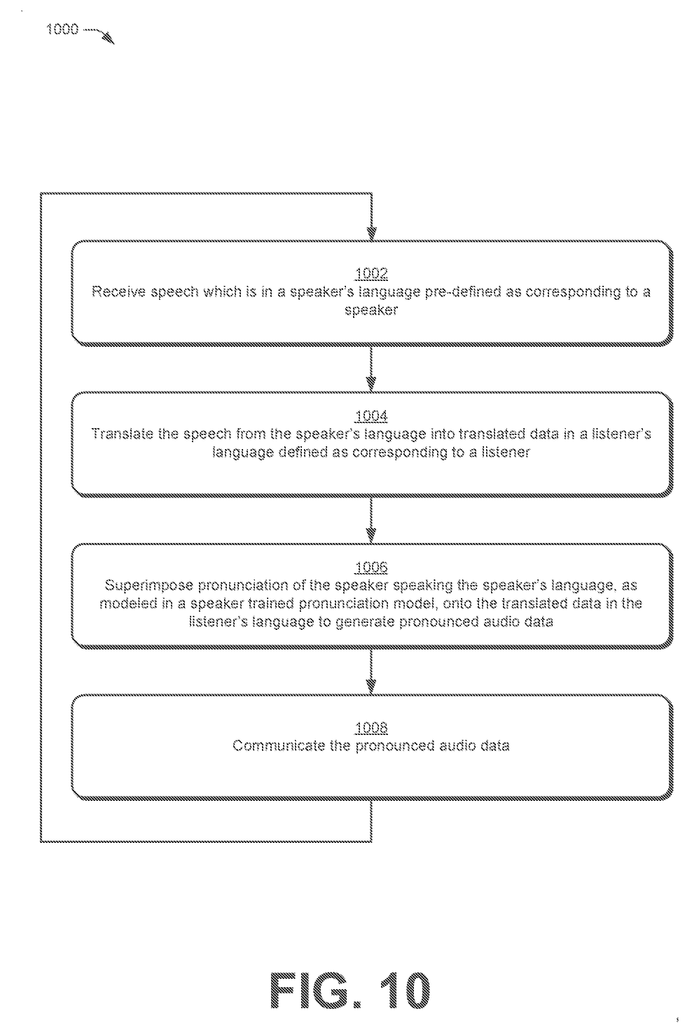

FIG. 10 illustrates a procedure 1000 in an example implementation of audio and language translation between computing devices. Most of the details implicated by FIG. 10 have been discussed above and are not repeated herein. The procedure 1000 can conveniently be implemented as instructions executed on the processor of a computing device, such as those described in connection with FIG. 9, or another apparatus appropriately arranged.

Speech which is in a speaker’s language, defined as corresponding to a speaker, is received (block 1002). The received speech is translated from the speaker’s language into translated data in a listener’s language defined as corresponding to a listener (block 1004).

Pronunciation of the speaker speaking the speaker’s language is superimposed onto the translated data in the listener’s language to generate pronounced audio data (block 1006). In accordance with the principles discussed herein, the pronunciation of the speaker speaking the speaker’s language is modeled by a trained pronunciation model. The pronounced audio data is communicated to a computing device of a listener (block 1008).

The procedure 1000 may repeatedly perform the above steps, for example, while a computing device continues to receive speech.

Having described examples of procedures in accordance with one or more implementations, consider now an example of a system and device that can be utilized to implement the various techniques described herein.

### Example System and Device

FIG. 11 illustrates an example of a system 1100 that includes an example computing device 1102 that is representative of one or more computing systems and/or devices that may implement the various techniques described herein. This is illustrated through inclusion of the speaker trained pronunciation model 130. The computing device 1102 may be, for example, a server of a service provider, a device associated with a client (for example, a client device), an on-chip system, and/or any other suitable computing device or computing system.

The example computing device 1102 as illustrated includes a processing system 1104, one or more computer-readable media 1106, and one or more input/output (I/O) interfaces 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including one or more hardware elements 1110 that may be configured as processors, functional blocks, and so forth. This may include implementation in hardware as an application specific integrated circuit or other logic device formed using one or more semiconductors. The one or more hardware elements 1110 are not limited by the materials from which they are formed or the processing mechanisms employed therein. For example, processors may be comprised of semiconductor(s) and/or transistors (for example, electronic integrated circuits (ICs)). In such a context, processor-executable instructions may be electronically-executable instructions.

The computer-readable media 1106 is illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (for example, RAM, ROM, a fixed hard drive, and so on) as well as removable media (for example, Flash memory, a removable hard drive, an optical disc, and so forth). The computer-readable media 1106 may be configured in a variety of other ways as further described herein.

I/O interface(s) 1108 are representative of functionality to allow a user to enter commands and information to computing device 1102, and also allow information to be presented to the user and/or other components or devices using various input/output devices. Examples of input devices include a keyboard, a cursor control device (for example, a mouse), a microphone, a scanner, touch functionality (for example, capacitive or other sensors that are configured to detect physical touch), a camera (for example, which may employ visible or non-visible wavelengths such as infrared frequencies to recognize movement as gestures that do not involve touch), and so forth. Examples of output devices include a display device (for example, a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the one or more hardware elements 1110 and the computer-readable media 1106 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, for example, the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of a module that is executable by the computing device 1102 as software may be achieved at least partially in hardware, for example, through use of computer-readable storage media and/or one or more hardware elements 1110 of the processing system 1104. The instructions and/or functions may be executable/operable by one or more articles of manufacture (for example, one or more computing devices 1102 and/or processing systems 1104) to implement techniques, modules, and examples described herein.

The techniques described herein may be supported by various configurations of the computing device 1102 and are not limited to the specific examples of the techniques described herein. This functionality may also be implemented all or in part through use of a distributed system, such as over a cloud 1118 via a platform 1120 as described below.

The cloud 1118 may include and/or may represent the platform 1120 for resources 1116. The platform 1120 abstracts underlying functionality of hardware (for example, servers) and software resources of the cloud 1118. The resources 1116 may include applications and/or data that can be utilized while computer processing is executed on servers that are remote from the computing device 1102. The resources 1116 available through the cloud 1118 can also include services provided over the Internet and/or through a subscriber network, such as a cellular or Wi-Fi network. In FIG. 11, a communication session 142 is representative of such services.

The platform 1120 may abstract resources and functions to connect the computing device 1102 with other computing devices. The platform 1120 may also serve to abstract scaling of resources to provide a corresponding level of scale to encountered demand for the resources 1116 that are implemented via the platform 1120. Accordingly, in an interconnected device implementation, implementation of functionality described herein may be distributed throughout the system 1100. For example, the functionality may be implemented in part on the computing device 1102 as well as via the platform 1120 that abstracts the functionality of the cloud 1118.

In some aspects, the techniques described herein relate to a computer-implemented method for audio and language translation between a first computing device and a second computing device, including: receiving, by the first computing device, speech from a speaker, the speech being in a speaker's language pre-defined as corresponding to the speaker; responsive to receiving the speech, translating the speech from the speaker's language into translated data in a listener's language pre-defined as corresponding to a listener at the second computing device; superimposing, by the first computing device, pronunciation of the speaker as modeled by a speaker pronunciation model onto the translated data to generate pronounced audio data in the listener's language modeled so as to sound as if pronounced by the speaker, the speaker pronunciation model being trained on a voice of the speaker speaking the speaker's language, and the speaker pronunciation model being stored at the first computing device; and communicating the pronounced audio data to the second computing device as the speech is being received by the first computing device.

In some aspects, the techniques described herein relate to a computer-implemented method, wherein: the superimposing includes overlaying the pronunciation of the speaker onto words in the translated data, as indicated by a superimposition model of the listener's language that models generic pronunciation of the words in the listener's language, to generate the pronounced audio data; and the speaker pronunciation model and the superimposition model map one or more of timbre, pitch, amplitude, and articulation to words and spoken patterns.

In some aspects, the techniques described herein relate to a computer-implemented method, wherein: the first computing device and the second computing device are configured for communicating with each other during a communication session via a communication server; the superimposing is performed via a communication session client executing on the first computing device; and the translating is performed at least one of in the communication session client executing on the first computing device or at least partly at the communication server.

In some aspects, the techniques described herein relate to a computer-implemented method, wherein the speaker pronunciation model is not communicated off the first computing device.

In some aspects, the techniques described herein relate to a computer-implemented method, further including using a graphical processing unit (GPU) of the first computing device to perform at least one of the translating or the superimposing.

In some aspects, the techniques described herein relate to a computer-implemented method, further including training, at the first computing device, the speaker pronunciation model by: receiving training speech spoken by the speaker in the speaker's language; extracting pronunciation characteristics of the speaker from the received training speech, including one or more of timbre, pitch, amplitude, and articulation; and adding the extracted pronunciation characteristics to the speaker pronunciation model for use in the superimposing.

In some aspects, the techniques described herein relate to a computer-implemented method, further including storing, at the first computing device, at least one translation model or conversion model which models speech-to-text conversion in the speaker's language, models text translation from the speaker's language to the listener's language, and models text-to-audio conversion in the listener's language, the translating being performed using the at least one translation model or conversion model.

In some aspects, the techniques described herein relate to a computer-implemented method, further including: participating, by the first computing device, in a communication session via a communication session server with the second computing device; and providing, by the first computing device, the pronounced audio data to a communication session server for further routing to the second computing device.

In some aspects, the techniques described herein relate to a computer-implemented method, further including encrypting, by the first computing device and before the communicating, the pronounced audio data, wherein the pronounced audio data communicated to the second computing device is encrypted.

In some aspects, the techniques described herein relate to a computing device including: local computer-readable storage media; an audio input device operable to receive speech; a speaker pronunciation model being stored on the local computer-readable storage media of the computing device; and at least one processor operable with the audio input device, and configured to: receive, via the audio input device, speech from a speaker, the speech being in a speaker's language pre-defined as corresponding to the speaker; responsive to receiving the speech, translate the speech from the speaker's language into translated data in a listener's language pre-defined as corresponding to a listener at an additional computing device; superimpose pronunciation of the speaker as modeled by the speaker pronunciation model onto the translated data to generate pronounced audio data in the listener's language modeled so as to sound as if pronounced by the speaker, the speaker pronunciation model being trained on a voice of the speaker speaking the speaker's language; and communicate the pronounced audio data to the additional computing device as the speech is being received by the audio input device.

In some aspects, the techniques described herein relate to a computing device, wherein: to superimpose the pronunciation of the speaker onto the translated data, the at least one processor is further configured to overlay the pronunciation of the speaker onto words in the translated data as indicated by a superimposition model of the listener's language that models generic pronunciation of the words in the listener's language, to generate the pronounced audio data; and the speaker pronunciation model and the superimposition model map one or more of timbre, pitch, amplitude, and articulation to words and spoken patterns.

In some aspects, the techniques described herein relate to a computing device, wherein: the computing device is configured to communicate with the additional computing device during a communication session via a communication server; the pronunciation is superimposed in a communication session client executing on the computing device; and the translation is performed at least one of in the communication session client executing on the computing device or at least partly at the communication server.

In some aspects, the techniques described herein relate to a computing device, wherein the at least one processor is further configured to synchronize the pronounced audio data and video data for synchronous output at the additional computing device.

In some aspects, the techniques described herein relate to a computing device, wherein the at least one processor includes a graphical processing unit (GPU) configured to at least one of translate the speech from the speaker's language into the translated data in the listener's language or superimpose the pronunciation of the speaker.

In some aspects, the techniques described herein relate to a computing device, wherein the at least one processor is further configured to train the speaker pronunciation model, including to: receive training speech spoken by the speaker in the speaker's language; extract pronunciation characteristics of the speaker from the received training speech, including one or more of timbre, pitch, amplitude, and articulation in the received training speech; and add the extracted pronunciation characteristics to the speaker pronunciation model to superimpose the pronunciation of the speaker.

In some aspects, the techniques described herein relate to a computing device, wherein the at least one processor is further configured to store at least one translation model or conversion model which models speech-to-text conversion in the speaker's language, models text translation from the speaker's language to the listener's language, and models text-to-audio conversion in the listener's language, wherein the translation is performed using the at least one translation model or conversion model.

In some aspects, the techniques described herein relate to a computing device, wherein the at least one processor is further configured to: cause the computing device to participate in a communication session via a communication session server; and transmit the pronounced audio data to the communication session server for transmission from the communication session server to the additional computing device.

In some aspects, the techniques described herein relate to a computing device, wherein the at least one processor is further configured to encrypt, before the communication, the pronounced audio data, wherein the pronounced audio data communicated to the additional computing device is encrypted.

In some aspects, the techniques described herein relate to one or more computer-readable storage media storing computer-executable instructions that, responsive to execution by one or more processors, perform operations including: receiving, by a first computing device, speech from a speaker, the speech being in a speaker's language pre-defined as corresponding to the speaker; responsive to receiving the speech, translating the speech from the speaker's language into translated data in a listener's language pre-defined as corresponding to a listener at a second computing device; superimposing, by the first computing device, pronunciation of the speaker as modeled by a speaker pronunciation model onto the translated data to generate pronounced audio data in the listener's language modeled so as to sound as if pronounced by the speaker, the speaker pronunciation model being trained on a voice of the speaker speaking the speaker's language, and the speaker pronunciation model being stored at the first computing device; and communicating the pronounced audio data to the second computing device as the speech is being received by the first computing device.

In some aspects, the techniques described herein relate to one or more computer-readable storage media, wherein the first computing device and the second computing device are a same computing device.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving, by a first computing device, speech from a speaker, the speech being in a speaker’s language pre-defined as corresponding to the speaker;
responsive to receiving the speech, translating the speech from the speaker’s language into translated data in a listener’s language corresponding to a second computing device;
superimposing, by the first computing device, pronunciation of the speaker as modeled by a speaker pronunciation model onto the translated data to generate pronounced audio data in the listener’s language modeled so as to sound as if pronounced by the speaker, the speaker pronunciation model being trained on a voice of the speaker speaking the speaker’s language, and the speaker pronunciation model being stored at the first computing device; and
communicating the pronounced audio data to the second computing device as the speech is being received by the first computing device.

2. The computer-implemented method of claim 1, wherein:
the superimposing includes overlaying the pronunciation of the speaker onto words in the translated data, as indicated by a superimposition model of the listener’s language that models generic pronunciation of the words in the listener’s language, to generate the pronounced audio data; and
the speaker pronunciation model and the superimposition model map one or more of timbre, pitch, amplitude, and articulation to words and spoken patterns.

3. The computer-implemented method of claim 1, wherein:
the first computing device and the second computing device are configured for communicating with each other during a communication session via a communication server;
the superimposing is performed via a communication session client executing on the first computing device; and
the translating is performed at least one of in the communication session client executing on the first computing device or at least partly at the communication server.

4. The computer-implemented method of claim 1, wherein the speaker pronunciation model is not communicated off the first computing device.

5. The computer-implemented method of claim 1, further comprising using a graphical processing unit (GPU) of the first computing device to perform at least one of the translating or the superimposing.

6. The computer-implemented method of claim 1, further comprising training, at the first computing device, the speaker pronunciation model by:
receiving training speech spoken by the speaker in the speaker’s language;
extracting pronunciation characteristics of the speaker from the received training speech, including one or more of timbre, pitch, amplitude, and articulation; and
adding the extracted pronunciation characteristics to the speaker pronunciation model for use in the superimposing.

7. The computer-implemented method of claim 1, further comprising storing, at the first computing device, at least one translation model or conversion model which models speech-to-text conversion in the speaker’s language, models text translation from the speaker’s language to the listener’s language, and models text-to-audio conversion in the listener’s language, the translating being performed using the at least one translation model or conversion model.

8. The computer-implemented method of claim 1, further comprising:
participating, by the first computing device, in a communication session via a communication session server with the second computing device; and
providing, by the first computing device, the pronounced audio data to a communication session server for further routing to the second computing device.

9. The computer-implemented method of claim 1, further comprising encrypting, by the first computing device and before the communicating, the pronounced audio data, wherein the pronounced audio data communicated to the second computing device is encrypted.

10. A computing device comprising:
local computer-readable storage media;
an audio input device operable to receive speech;
a speaker pronunciation model being stored on the local computer-readable storage media of the computing device; and
at least one processor operable with the audio input device, and configured to:
receive, via the audio input device, speech from a speaker, the speech being in a speaker’s language pre-defined as corresponding to the speaker;
responsive to receiving the speech, translate the speech from the speaker’s language into translated data in a listener’s language corresponding to an additional computing device;
superimpose pronunciation of the speaker as modeled by the speaker pronunciation model onto the translated data to generate pronounced audio data in the listener’s language modeled so as to sound as if pronounced by the speaker, the speaker pronunciation model being trained on a voice of the speaker speaking the speaker’s language; and
communicate the pronounced audio data to the additional computing device as the speech is being received by the audio input device.

11. The computing device of claim 10, wherein:
to superimpose the pronunciation of the speaker onto the translated data, the at least one processor is further configured to overlay the pronunciation of the speaker onto words in the translated data as indicated by a superimposition model of the listener’s language that models generic pronunciation of the words in the listener’s language, to generate the pronounced audio data; and
the speaker pronunciation model and the superimposition model map one or more of timbre, pitch, amplitude, and articulation to words and spoken patterns.

12. The computing device of claim 10, wherein:
the computing device is configured to communicate with the additional computing device during a communication session via a communication server;
the pronunciation is superimposed in a communication session client executing on the computing device; and
the translation is performed at least one of in the communication session client executing on the computing device or at least partly at the communication server.

13. The computing device of claim 10, wherein the at least one processor is further configured to synchronize the pronounced audio data and video data for synchronous output at the additional computing device.

14. The computing device of claim 10, wherein the at least one processor comprises a graphical processing unit (GPU) configured to at least one of translate the speech from the speaker’s language into the translated data in the listener’s language or superimpose the pronunciation of the speaker.

15. The computing device of claim 10, wherein the at least one processor is further configured to train the speaker pronunciation model, including to:
receive training speech spoken by the speaker in the speaker’s language;
extract pronunciation characteristics of the speaker from the received training speech, including one or more of timbre, pitch, amplitude, and articulation in the received training speech; and
add the extracted pronunciation characteristics to the speaker pronunciation model to superimpose the pronunciation of the speaker.

16. The computing device of claim 10, wherein the at least one processor is further configured to store at least one translation model or conversion model which models speech-to-text conversion in the speaker’s language, models text translation from the speaker’s language to the listener’s language, and models text-to-audio conversion in the listener’s language, wherein the translation is performed using the at least one translation model or conversion model.

17. The computing device of claim 10, wherein the at least one processor is further configured to:
cause the computing device to participate in a communication session via a communication session server; and
transmit the pronounced audio data to the communication session server for transmission from the communication session server to the additional computing device.

18. The computing device of claim 10, wherein the at least one processor is further configured to encrypt, before the communication, the pronounced audio data, wherein the pronounced audio data communicated to the additional computing device is encrypted.

19. One or more computer-readable storage media storing computer-executable instructions that, responsive to execution by one or more processors, perform operations comprising:
receiving, by a first computing device, speech from a speaker, the speech being in a speaker’s language pre-defined as corresponding to the speaker;
responsive to receiving the speech, translating the speech from the speaker’s language into translated data in a listener’s language corresponding to a second computing device;
superimposing, by the first computing device, pronunciation of the speaker as modeled by a speaker pronunciation model onto the translated data to generate pronounced audio data in the listener’s language modeled so as to sound as if pronounced by the speaker, the speaker pronunciation model being trained on a voice of the speaker speaking the speaker’s language, and the speaker pronunciation model being stored at the first computing device; and
communicating the pronounced audio data to the second computing device as the speech is being received by the first computing device.

20. The one or more computer-readable storage media of claim 19, wherein the first computing device and the second computing device are a same computing device.
